(19) United States
(12) Patent Application Publication
(10) Pub. No.: US 2016/0043895 A1
(43) Pub. Date: Feb. 11, 2016

(54) TONING CONTROL METHOD OF WIFI DEVICE SETTING BY SMART DEVICE

(71) Applicant: National Taipei University of Technology, Taipei City (TW)

(72) Inventors: Shaw Hwa HWANG, Taipei City (TW); Cheng Yu YEH, Taipei City (TW); Kuan Lin CHEN, Taipei City (TW); Yao Hsing CHUNG, Taipei City (TW); Chi Jung HUANG, Taipei City (TW); Li Te SHEN, Taipei City (TW); Shun Chieh CHANG, Taipei City (TW); Bing Chih YAO, Taipei City (TW); Chao Ping CHU, Taipei City (TW); Ning Yun KU, Taipei City (TW); Tzu Hung LIN, Taipei City (TW); Ming Che YEH, Taipei City (TW)

(21) Appl. No.: 14/465,351

(22) Filed: Aug. 21, 2014

(30) Foreign Application Priority Data
Aug. 7, 2014 (TW) 103127022

(51) Int. Cl. H04L 12/24; H04M 7/12; H04L 27/10; H04W 12/06

(52) U.S. Cl. CPC H04L 41/08; H04W 12/06; H04M 7/1295; H04L 27/10

(57) ABSTRACT

The present invention provides a toning control method for setting a WiFi device by a smart device so that the WiFi device can link with Internet through a WiFi AP. The present invention is different from the prior art that a smart phone uses WiFi signal to set an IP camera, and is also different from the prior art that a smart phone generates QR Code for setting an IP camera. The present invention adopts methods of DTMF (Dual-Tone Multi-Frequency) or FSK (Frequency-Shift Keying) for toning encoding, and sends the toning encoding through a loudspeaker of the smart device to a toning decoder of the WiFi device for toning decoding, then performs the setting and linking of the WiFi device.

### FIELD OF THE INVENTION

The present invention relates to a method for setting a WiFi device so that the WiFi device can link with Internet through a WiFi AP (Access Point), and more particularly to a toning control method for setting the WiFi device by a smart device.

### BACKGROUND OF THE INVENTION

Referring to FIG. 1, an IP camera 1 linked with Internet 3 by a

WiFi AP 2 is shown schematically. The IP camera 1 is a device capable of WiFi linking, so called a “WiFi device”. The IP camera 1 must provide an SSID (Service Set Identifier) of the WiFi AP 2 and a password of the WiFi AP 2 to the WiFi AP 2 first, after an authentication by the WiFi AP 2 successfully, the IP camera 1 can then link with Internet 3 to provide images and voices captured to a user who uses a smart phone or a PC to access Internet 3. The IP camera 1 is now on a station mode.

This is the same as the way that a smart phone 4 links with Internet 3 through the WiFi AP 2. As shown in FIG. 1, if the smart phone 4 wants to link with Internet 3 through the WiFi AP 2, an SSID of the WiFi AP 2 and a password of the WiFi AP 2 have to be provided to the WiFi AP 2, after an authentication by the WiFi AP 2 successfully, the smart phone 4 can then link with Internet 3.

As to how to provide the SSID of the WiFi AP 2 and the password of the WiFi AP 2 by the IP camera 1 to the WiFi AP 2, a user's setting is needed.

The first method of the user's setting is shown in FIG. 2. IP camera 1 has a switch to change the IP camera 1 from a station mode to an AP mode. The user cancels the linking of the smart phone 4 to the WiFi AP 2, and then the smart phone 4 provides an SSID of the IP camera 1 to the IP camera 1 so as to link with the IP camera 1 by WiFi signals. Thereafter the user clicks out an application program 5 from the screen of the smart phone 4, fills in the SSID and password of the WiFi AP 2, and then informs the IP camera 1 by WiFi signals for setting. After then the user switches back the IP camera 1 from the AP mode to the station mode. The IP camera 1 sends out the SSID and password of the WiFi AP 2, after an authentication by the WiFi AP 2 successfully, the IP camera 1 can then link with Internet 3. The smart phone 4 recovers the linking with the WiFi AP 2. This method is somewhat complicated.

Referring to FIG. 3, the second method of the user's setting is described. The IP camera 1 maintains the station mode. The user does not cancel the linking of the smart phone 4 to the WiFi AP 2. The user clicks out an application program 6 from the screen of the smart phone 4, fills in the SSID and password of the WiFi AP 2, and then a QR Code (Quick Response Code) 7 is generated on the screen of the smart phone 4. The QR Code 7 displayed on the screen of the smart phone 4 is aimed at the IP camera 1 for taking picture by the IP camera 1, so that the IP camera 1 is set with the SSID and password of the WiFi AP 2. The IP camera 1 sends out the SSID and password of the WiFi AP 2, after an authentication by the WiFi AP 2 successfully, the IP camera 1 can then link with Internet 3. But taking QR Code picture by this way, the focus is often not accurate to cause failure.

### SUMMARY OF THE INVENTION

The object of the present invention is to provide a toning control method of a WiFi device setting by a smart device, and more particularly to use DTMF (Dual-Tone Multi-Frequency) and FSK (Frequency-Shift Keying) for implementing the toning encoding and decoding.

In a system of linking a WiFi device to Internet through a WiFi AP, a smart device is used for setting the WiFi device by the toning control method. The toning control method comprises steps as below:
a. a toning decoder of the WiFi device begins recording;
b. an application program is clicked out from a screen of the smart device, an SSID and a password of the WiFi AP are filled in;
c. encoding the SSID and the password by the smart device sequentially to generate a series of toning signals; a loudspeaker of the smart device sends the series of toning signals to the toning decoder for decoding;
d. after decoding by the toning decoder successfully, the WiFi device is set with the SSID and the password of the WiFi AP; the WiFi device sends out the SSID and the password of the WiFi AP to the WiFi AP;
e. after an authentication by the WiFi AP successfully, the WiFi device can then link with Internet through the WiFi AP, and generate a correct lamp signal;
f. if the authentication by the WiFi AP is failed, then the WiFi device generates an abnormal lamp signal, go back to step a for resetting;
g. in step d, if the decoding is failed, then the WiFi device generates a wrong lamp signal, go back to step c, the smart device encodes again the SSID and the password sequentially to generate the series of toning signals, then enter step d for decoding.

The encoding and the decoding in step c use DTMF (Dual-Tone Multi-Frequency) to implement.

The encoding and the decoding in step c use FSK (Frequency-Shift Keying) to implement.

The smart device is a smart phone or a smart tablet PC.

The WiFi device is an IP camera, a wireless personal cloud storage, a smart device or a wireless bridge.

### BRIEF DESCRIPTION OF THE DRAWINGS

FIG. 1 shows schematically the linking of an IP camera with Internet through a WiFi AP.

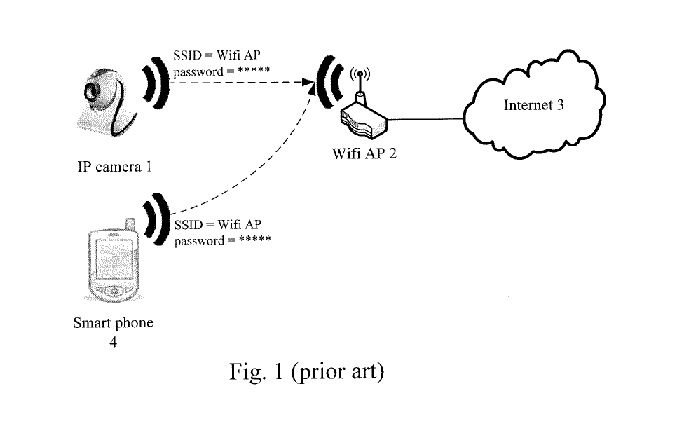

FIG. 2 shows schematically the first method of the user's setting for the IP camera.

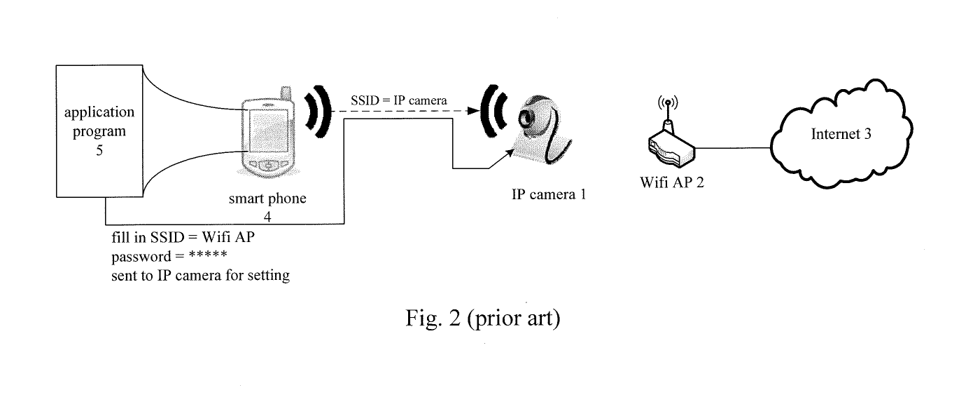

FIG. 3 shows schematically the second method of the user's setting for the IP camera.

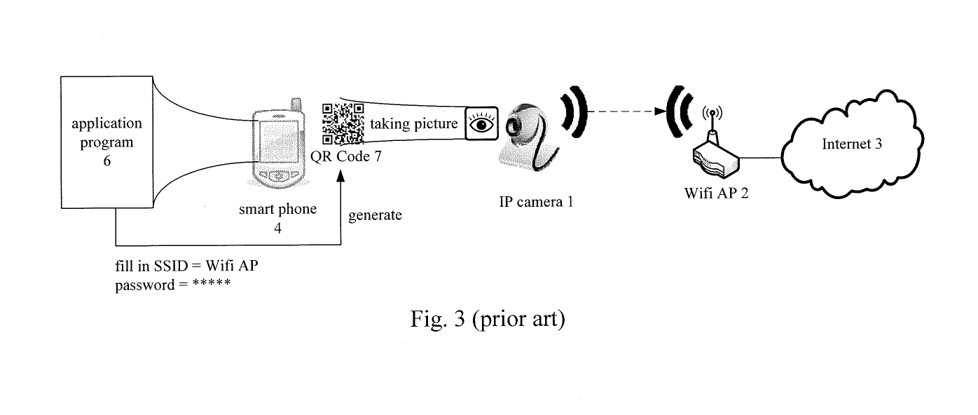

FIG. 4 shows schematically the toning control method for setting the IP camera by a smart phone according to the present invention.

FIG. 5 shows schematically the flow chart of the toning control method for setting the IP camera by a smart phone according to the present invention.

FIG. 6 shows schematically the toning encoding and decoding according to the present invention.

FIG. 7 shows schematically the DTMF.

FIG. 8 shows schematically the toning encoding and decoding of the DTMF by way of example.

FIG. 9 shows schematically the toning encoding and decoding of the FSK by way of example.

### DETAILED DESCRIPTIONS OF THE PREFERRED EMBODIMENTS

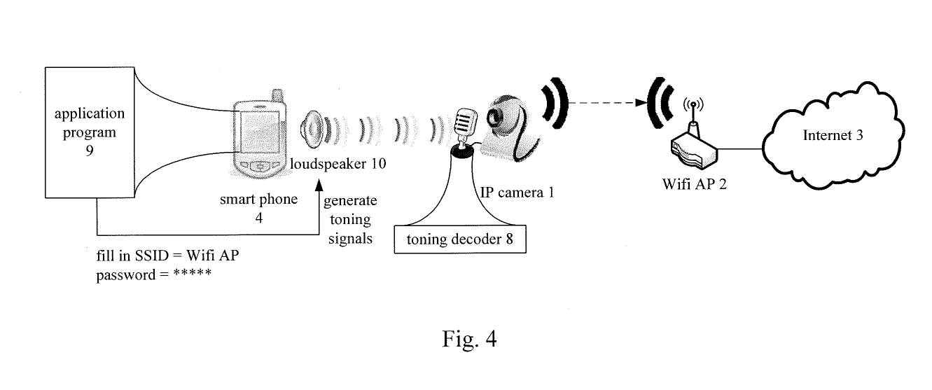

Referring to FIG. 4, an embodiment according to the present invention is described for toning control method of an IP camera setting by a smart phone. Basically an IP camera 1 is allocated with a microphone, which is called toning decoder 8 in the present invention. The IP camera 1 has a push button for changing the IP camera 1 from a station mode to a setting mode. The smart phone 4 does not have to cancel the linking with the WiFi AP 2. Thereafter the user clicks out an application program 9 from the screen of the smart phone 4, fills in the SSID and the password of the WiFi AP 2, and then encodes the SSID and the password sequentially to generate a series of toning signals for sending through a loudspeaker 10 of the smart phone 4 to the toning decoder 8 for decoding. After decoding, the IP camera 1 is set with the SSID and the password of the WiFi AP 2. The IP camera 1 sends out the SSID and the password of the WiFi AP 2, after an authentication by the WiFi AP 2 successfully, the IP camera 1 can then link with Internet 3 to provide images and voices captured to a user who uses a smart phone or a PC to access Internet 3.

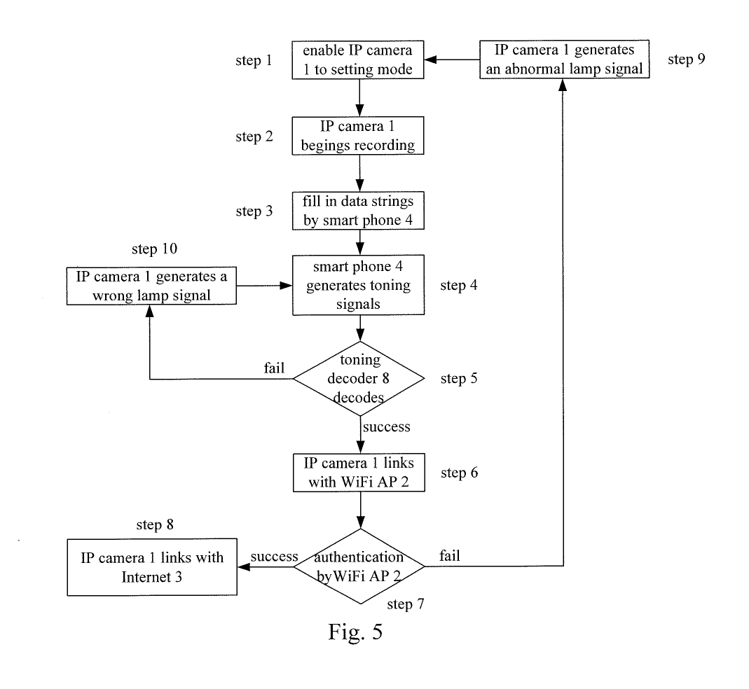

Referring to FIG. 5, a flow chart of the toning control method for setting an IP camera by a smart phone according to the present invention is described. In step 1, a push button of the IP camera 1 is pushed for changing the IP camera 1 from a station mode to a setting mode. In step 2, the toning decoder 8 of the IP camera 1 begins recording. In step 3, the user clicks out an application program 9 from the screen of the smart phone 4, fills in the SSID and the password of the WiFi AP 2. In step 4, the smart phone 4 encodes the SSID and the password sequentially to generate a series of toning signals. In step 5, a loudspeaker 10 of the smart phone 4 sends the series of toning signals 4 to the toning decoder 8 for decoding. In step 6, after decoding successfully, the IP camera 1 is set with the SSID and the password of the WiFi AP 2, the IP camera 1 sends out the SSID and the password of the WiFi AP 2. In step 7, after an authentication by the WiFi AP 2 successfully, the IP camera 1 can then link with Internet 3 (step 8), and generate a correct lamp signal, and provide images and voices captured to a user who uses a smart phone or a PC to access Internet 3; if the authentication by the WiFi AP 2 is failed, then enter step 9, the IP camera 1 generates an abnormal lamp signal, then go back to step 1 for resetting. In step 5, if the decoding is failed, enter step 10, the IP camera 1 generates a wrong lamp signal, then go back to step 4, the smart phone 4 encodes again the SSID and the password sequentially to generate a series of toning signals, then enter step 5 for decoding.

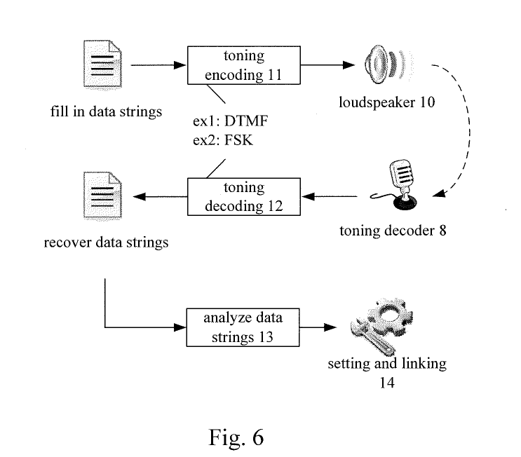

Referring to FIG. 6, the toning encoding and decoding according to the present invention is described. In the application program 9, data strings (the SSID and the password of the WiFi AP 2) are filled in, and use DTMF (Dual-Tone Multi-Frequency) or FSK (Frequency-Shift Keying) to implement the toning encoding 11, and then pass through the loudspeaker 10 for being sent to the toning decoder 8 for toning decoding 12. After the toning decoding 12, the original data strings is recovered, then “analyze the data strings” 13 for performing the “setting and linking” 14 of the IP camera 1.

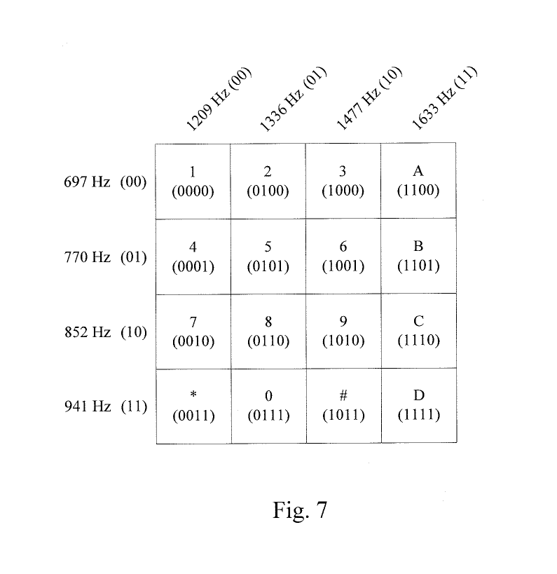

Referring to FIG. 7, the DTMF (Dual-Tone Multi-Frequency) is shown schematically. DTMF is broadly used in toning encoding system of the telephone key. For example, if the key “1” is pushed, a combination of two toning signals 1209 Hz and 697 Hz is generated, and so on.

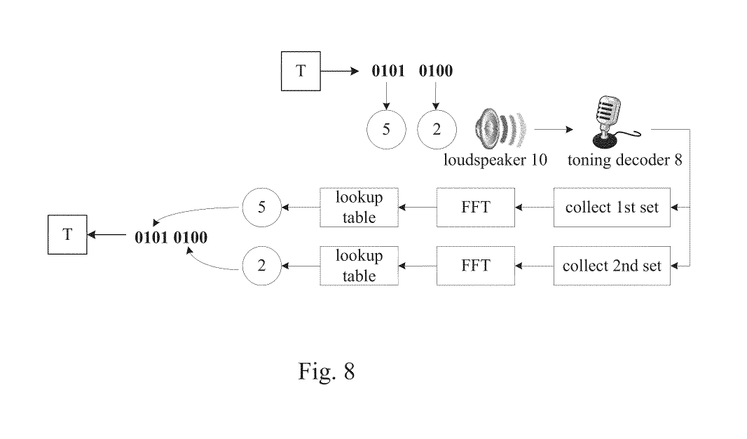

Referring to FIG. 8, the toning encoding and decoding of the DTMF is shown by way of example. If the data string is “T”, the ASCII (American Standard Code for Information Interchange) code thereof is “0101 0100”, the first four codes are “0101”, which is equal to the codes of the telephone key “5”, the second four codes are “0100”, which is equal to the codes of the telephone key “2” (please see FIG. 7). According to the toning encoding system shown in FIG. 7, the loudspesker 10 sends “5” and “2” related two toning signals respectively and sequentially, and received by the toning decoder 8. The toning decoder 8 collects the first set of two toning signals then the second set of two toning signals sequentially, and uses FFT (Fast Fourier Transform) for being transferred into two sets of two toning signals. By looking up the table shown in FIG. 7, “5” and “2” keys are recovered, and finally being transferred into ASCII code “0101 0100” to get the “T” word.

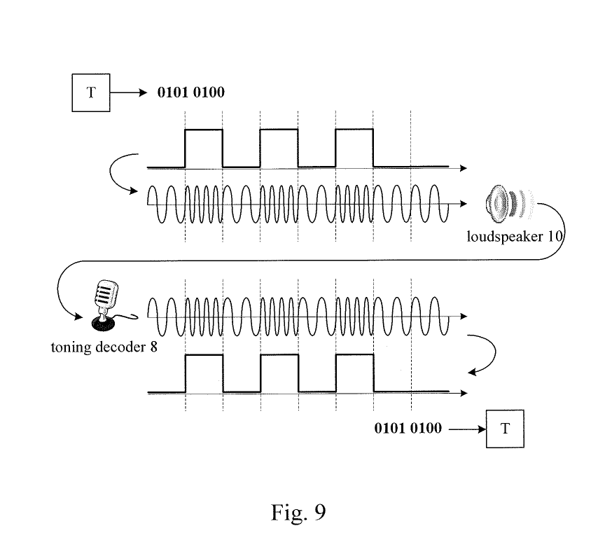

Referring to FIG. 9, the toning encoding and decoding of the FSK is shown by way of example. If the data string is “T”, the ASCII code thereof is “0101 0100”, and let the square wave of “0101 0100” be transferred into two sinusoidal waves with different frequencies, as shown in the figure. The loudspesker 10 sends the two sinusoidal waves for being received by the toning decoder 8, and then let the two sinusoidal waves be transferred into the square wave of “0101 0100”, the “T” word is obtained.

The smart phone 4 in the aforementioned embodiment can be replaced by a smart tablet PC. The smart phone and the smart tablet PC are called “smart device” in the present invention in general.

The IP camera 1 in the aforementioned embodiment can be replaced by a wireless personal cloud storage. The wireless personal cloud storage is a device capable of WiFi linking (i.e. a WiFi device), and can link with Internet 3 through WiFi AP 2. A user uses a smart phone or a PC to access Internet 3 remotely so as to get the data of the wireless personal cloud storage. The way to set the wireless personal cloud storage is the same as the way to set the IP camera 1 in the aforementioned embodiment.

The IP camera 1 in the aforementioned embodiment can be replaced by a smart device (a smart phone or a smart tablet PC).

The smart device is a device capable of WiFi linking (i.e. a WiFi device), and can link with Internet 3 through the WiFi AP 2. At the first time to use the smart device, the SSID and the password of the WiFi AP 2 has to be set. The way to set the smart device is the same as the way to set the IP camera 1 in the aforementioned embodiment.

The IP camera 1 in the aforementioned embodiment can be replaced by a wireless bridge, such as the “RT-N12HPT” of ASUS, which is a device capable of WiFi linking (i.e. a WiFi device), and can link with Internet 3 through the WiFi AP 2. At the first time to use the wireless bridge, the SSID and the password of the WiFi AP 2 has to be set. The way to set the wireless bridge is the same as the way to set the IP camera 1 in the aforementioned embodiment.

The scope of the present invention depends upon the following claims, and is not limited by the above embodiments.

1. A toning control method of a WiFi device setting by a smart device, in a system of linking a WiFi device to Internet through a WiFi AP, a smart device is used for setting the WiFi device by the toning control method, comprising steps as below:
a. a toning decoder of the WiFi device begins recording;
b. an application program is clicked out from a screen of the smart device, an SSID and a password of the WiFi AP are filled in;
c. encoding the SSID and the password by the smart device sequentially to generate a series of toning signals; a loudspeaker of the smart device sends the series of toning signals to the toning decoder for decoding;
d. after decoding by the toning decoder successfully, the WiFi device is set with the SSID and the password of the WiFi AP; the WiFi device sends out the SSID and the password of the WiFi AP to the WiFi AP;
e. after an authentication by the WiFi AP successfully, the WiFi device can then link with Internet through the WiFi AP, and generate a correct lamp signal;
f. if the authentication by the WiFi AP is failed, then the WiFi device generates an abnormal lamp signal, go back to step a for resetting;
g. in step d, if the decoding is failed, then the WiFi device generates a wrong lamp signal, go back to step c, the smart device encodes again the SSID and the password sequentially to generate the series of toning signals, then enter step d for decoding.

2. The toning control method of a WiFi device setting by a smart device according to claim 1, wherein the encoding and the decoding in step c use DTMF (Dual-Tone Multi-Frequency) to implement.

3. The toning control method of a WiFi device setting by a smart device according to claim 1, wherein the encoding and the decoding in step c use FSK (Frequency-Shift Keying) to implement.

4. The toning control method of a WiFi device setting by a smart device according to claim 1, wherein the smart device is a smart phone or a smart tablet PC.

5. The toning control method of a WiFi device setting by a smart device according to claim 1, wherein the WiFi device is an IP camera, a wireless personal cloud storage, a smart device or a wireless bridge.
